(19) United States
(12) Patent Application Publication
(10) Pub. No.: US 2023/0109140 A1
(43) Pub. Date: Apr. 6, 2023

(54) METHOD FOR DETERMINING A HEAD RELATED TRANSFER FUNCTION AND HEARING DEVICE

(71) Applicant: Sivantos Pte. Ltd., Singapore (SG)

(72) Inventor: Julius Krieg, Erlangen (DE)

(21) Appl. No.: 17/938,368

(22) Filed: Oct. 6, 2022

(30) Foreign Application Priority Data
Oct. 6, 2021 (DE) 10 2021 211 278.1

(51) Int. Cl. H04S 7/00; H04R 25/00

(52) U.S. Cl. CPC H04S 7/303; H04R 25/305; H04R 25/505; H04S 2400/11; H04S 2420/01; H04S 2400/15

(57) ABSTRACT

In a method for determining a head related transfer function an audio source outputs a source audio signal, namely both acoustically as a sound signal and also non-acoustically as a data signal. The sound signal is received by the hearing aid of a user and is converted by this hearing aid back into an audio signal, namely into a first audio signal, wherein the data signal is received by the hearing aid or by another device, which generates a second audio signal from the data signal, wherein the first audio signal and the second audio signal are compared to one another and the HRTF is determined based thereon. There is also described a corresponding hearing aid.

The invention relates to a method for determining an HRTF and a hearing aid in which such an HRTF is usable. HRTF means “head-related transfer function”.

A hearing aid is generally used to output audio signals to a user. For this purpose, the hearing aid has at least one receiver (also called a loudspeaker), by means of which the audio signal is converted into a sound signal. The hearing aid is generally worn by the user in or on the ear. In one possible embodiment, the hearing aid is especially used to treat a hearing-impaired user. For this purpose, the hearing aid has a microphone which records sound signals from the environment and generates an audio signal therefrom, which is an electrical input signal. This is supplied to a signal processing unit of the hearing aid for modification. The modification takes place, for example, on the basis of an individual audiogram of the user, which is assigned to the hearing aid, so that an individual hearing deficit of the user is compensated for. The signal processing outputs an electrical output signal as a result, which is a modified audio signal and which is then converted via the receiver of the hearing aid back into a sound signal and is output to the user.

A hearing aid is either monaural and is then only worn on one side of the head or binaural and then has two individual devices, which are worn on different sides of the head. Depending on the type, the hearing aid is worn on, in, or behind the ear or a combination thereof. Common types of hearing aids are, e.g., BTE, RIC, and ITE hearing aids. These differ in particular in structural form and the way in which they are worn.

The HRTF is a transfer function which specifies how sound signals from the environment are modified on the path into the auditory canal of a person by their body shape, especially head shape (“head-related”). The HRTF is a transfer function especially for sound signals, i.e., acoustic signals. In a hearing aid, the HRTF is suitably used upon the modification in the signal processing unit and in particular enables items of spatial noise information (so-called “spatial cues”) to be retained or generated, so that the user can better locate the corresponding noise source.

Very generally, a sound signal propagates starting from an audio source into the environment and thus also reaches the ear and into the auditory canal of the user of a hearing aid. The path on which the sound signal enters the auditory canal is also referred to as an acoustic path. The modification of the sound signal along the acoustic path is dependent on the body of the user, especially on the respective shape of the torso and head, and very particularly on the ear shape, especially the shape of the outer ear (i.e., pinna). Consequently, the actual HRTF is regularly individual and different for each user. However, a non-individual HRTF is typically used, which is ascertained, for example, with the aid of a dummy (for example, KEMAR) and is then used for a large number of users different from one another. The individual body shape of the user is therefore regularly only taken into consideration inadequately, however, in any case possible deviations from the dummy remain unconsidered.

It is conceivable in principle to determine an individual HRTF for a respective user. For this purpose, the user is placed in the most echo-free room possible and subjected to sound signals from various sides. For this purpose, multiple loudspeakers are placed at fixed predetermined positions around the user. At the point at which the receiver of the hearing aid is to be seated later, i.e., in or on the ear of the user, a microphone is placed which receives the sound signals. By comparing the emitted sound signals to the received sound signals, the individual HRTF can then be determined. This method leads to a very good result, but is also very complex.

U.S. Pat. No. 9,591,427 B1 describes a method which is executed by a smart phone to generate HRTF of a person who wears headphones. Using a camera in the smart phone, based on an image of the face of the person, a position of the smart phone in relation to the face of the person is determined. While the smart phone is located in a hand of the person and close to the face of the person, a tone is generated using the smart phone, wherein the location of the smart phone in relation to the face of the person is also stored. The tone is then detected using a left microphone of the headphones in the left ear of the person and using a right microphone of the headphones in a right ear of the person. Finally, a left and a right HRTF are generated using the smart phone.

Against this background, it is an object of the invention to determine the HRTF in the most user-specific manner possible and to take into consideration the individual body shape of a user for this purpose. The determination of the HRTF is to be as simple as possible and is not to annoy the user if possible. For this purpose, a method for determining the HRTF is to be specified, for use with a hearing aid. Furthermore, a corresponding hearing aid is to be specified.

The object is achieved according to the invention by a method having the features as claimed in claim 1 and by a hearing aid as claimed in claim 15. Advantageous embodiments, refinements, and variants are the subject matter of the dependent claims. The statements in conjunction with the method also apply accordingly to the hearing aid and vice versa. When steps of the method are described hereinafter, expedient embodiments result for the hearing aid in particular in that it has a control unit which is designed to execute one or more of these steps.

One core concept of the present invention is in particular, for determining an HRTF for a specific user, to use an audio source which can output an audio signal both acoustically and also non-acoustically. The audio source is preferably a media device, i.e., a device for output and/or playback of media (for example, audio, video). The audio source is in particular repeatedly used by the user in their everyday life. The acoustically output audio signal propagates along an acoustic path to the user and especially up to a microphone of a hearing aid of the user and is modified along the acoustic path by the body shape of the user. This modification is defined by a transfer function which corresponds to the actual, individual HRTF of the user. The non-acoustically output audio signal, in contrast, is in particular not modified by this HRTF, so that the HRTF may be determined individually for the user by a comparison of the two different transmitted audio signals. This is implemented in the present case to then determine the HRTF in a user-specific manner. At the same time, the method can advantageously be carried out using greatly varying audio sources in the everyday life of the user and during the intended use of the hearing aid, thus in particular does not require a special measuring environment or measuring device properties and also only annoys the user minimally or not at all.

The method described here is generally used for determining an HRTF (i.e., “head-related transfer function”). The HRTF is used in particular in the intended operation of a hearing aid of a user. The determination of the HRTF is advantageously carried out in a user-specific manner for this user. “Determination” is understood in particular to mean that the HRTF is ascertained or measured. The HRTF is either determined newly from the ground up or determined starting from a base HRTF, which is not user-specific and is then adapted and preferably optimized in the context of the method to obtain a user-specific HRTF as a result. The HRTF is, for example, a parameterized function, having one or more parameters which are selected and/or adapted in the scope of the determination.

In the method, an audio source outputs a source audio signal, namely both acoustically as a sound signal and also non-acoustically as a data signal. The source audio signal is an audio signal and as such is in particular an electrical signal. The source audio signal is also referred to as the “original audio signal”. For the acoustic output of the source audio signal, the audio source has a loudspeaker, i.e., an electroacoustic transducer, using which the source audio signal is converted into a sound signal and output. The same source audio signal is also output on a further, non-acoustic channel, namely as a data signal. For the non-acoustic output of the source audio signal, the audio source has a data output, which outputs the source audio signal as a data signal and converts it for this purpose if necessary into a suitable data format. The data output is preferably an antenna for a wireless radio connection (for example, Bluetooth or Wi-Fi), so that the data signal is emitted wirelessly. A wired emission is also conceivable and suitable, however, the data output is then a corresponding terminal (for example, an audio socket or USB port). It is initially solely essential that the same audio signal (namely the source audio signal) is output on two different channels, namely once acoustically as a sound signal and once non-acoustically (for example, electrically, electromagnetically, optically) as a data signal.

The sound signal is received by the hearing aid and converted thereby back into an audio signal, namely into a first audio signal. This first audio signal is also referred to as an “acoustically transferred audio signal”, since it results from the source audio signal by conversion into a sound signal and back conversion from this sound signal. Especially in the case of a hearing aid for treating a hearing-impaired user, receiving sound signals from the environment is an original function of the hearing aid.

The data signal is received by the hearing aid or by another device which generates a second sound signal from the data signal, in particular by means of a data input, for example, an antenna. The other device—if provided—is in particular an auxiliary device which is connected to the hearing aid for data exchange, for example, via Bluetooth or Wi-Fi. The other device is, for example, a smart phone. In principle, it is also possible that the audio source itself is the other device, however, it is presumed hereinafter without restriction of the generality that this is not the case. The second audio signal is also referred to as a “non-acoustically transferred audio signal”, since it results from the source audio signal or is even identical thereto, without having been acoustically transferred. Outside of the fact that the sound signal and the data signal are transferred in two different ways viewed physically, the sound signal and the data signal are preferably also transferred in different frequency ranges. The sound signal is thus in particular transferred in the audible frequency range from 20 Hz to 20 kHz, the data signal is transferred in a communication frequency range, for example, between 1 MHz and 10 GHz and in any case at a frequency which is multiple orders of magnitude greater.

The first and the second audio signal are each a transferred (and thus possibly also modified) version of the source audio signal. For the sake of completeness, the source audio signal is also referred to as a “third audio signal”.

The first audio signal and the second audio signal, i.e., the audio signals transferred on different channels, are compared to one another and based thereon, i.e., based on the comparison, the HRTF is determined. This is based on the consideration that the second audio signal typically substantially corresponds to the source audio signal and has not been influenced at least by the HRTF. In contrast thereto, the sound signal was modified by the HRTF, so that the first audio signal accordingly differs from the source audio signal. In a first approximation, the following relationship accordingly applies between the first, acoustically transferred audio signal A1 and the second, non-acoustically transferred audio signal A2: A2=HRTF(A1). Precisely how the comparison is carried out is incidental as such. It is more important that an audio signal uninfluenced by the HRTF is available with the data signal, which is used as a reference signal to determine the actual, user-specific HRTF.

In one suitable embodiment, to determine the HRTF, the first audio signal is used as an intended signal and the second audio signal as an actual signal. In this way, the HRTF is determined in dependence on the difference between the sound signal and the data signal (more precisely in dependence on the difference between the first and the second audio signal). How the HRTF is specifically calculated is primarily incidental and is dependent in particular on how the HRTF is parameterized, i.e., by which parameters it is defined. In principle, it is possible to carry out a numeric optimization using corresponding computing power. For this purpose, individual parameters (also coefficients) are varied until a minimal deviation is achieved (i.e., a minimum or at least a stable and possibly only local minimum). A suitable algorithm for optimizing is, for example, LASSO (i.e., “least absolute shrinkage and selection operator”).

The HRTF determined in the above-mentioned manner is stored in particular in the hearing aid and preferably used by a signal processing unit of the hearing aid in operation, in order as a result to adapt the sound signal which is output by the hearing aid to the user. The purpose for which the HRTF is specifically used is of no further importance here. Possible uses of the HRTF are, for example, generating acoustic instructions which are provided with spatial information and are suitable for navigation of a walking user, adding an item of spatial information to a streaming signal so that this sounds to the user as if it comes from an audio source, for example, a television from a specific spatial direction. A further exemplary use of the HRTF are virtual operating elements, in which, for example, a position of an operating element, for example, a slide controller, is acoustically represented using a spatial effect (for example, emphasizing the right or left side depending on the setting of the operating element). Especially in conjunction with “in-ear” headphones, the use of an HRTF for modifying the audio output is advantageous.

In a specific, suitable embodiment, to determine the HRTF, only excerpts, so-called samples, are taken from the first and the second audio signal and stored as a data set. The two excerpts (one excerpt from the first audio signal and one excerpt from the second audio signal) of a respective data set preferably originate from the same time interval or have a corresponding timestamp. It is thus ensured that the HRTF is actually also determined correctly by a comparison of the two sections. A large number of such data sets are typically recorded and stored and evaluated to determine the HRTF. This takes place either on the hearing aid, on an auxiliary device as described, or on a separate computer, for example, a server.

An HRTF is preferably parameterized as already indicated, i.e., a function having a number of parameters which can vary depending on the user. Upon the determination of the HRTF, in particular these parameters are optimized and thus adapted in a user-specific manner. The determination of the HRTF preferably takes place progressively, so that the HRTF used approximates the actual, individual HRTF more and more with time. The method is insofar then iterative. Moreover, changes in the body shape of the user are thus also advantageously taken into consideration.

Without restriction of the generality, it is presumed in the present case that the hearing aid is a hearing aid to treat a hearing-impaired user. The invention is also applicable to other hearing aids, however, for example, a set of headphones which additionally has one or more microphones. A hearing aid to treat a hearing-impaired user generally has an input transducer, a signal processing unit, and an output transducer. The input transducer is a microphone here and is used to record sound signals from the environment, i.e., also to receive the sound signal here, which is emitted from the audio source. The output transducer is typically a receiver, which is also referred to as a loudspeaker. In the present case, without restriction of the generality, a hearing aid having a receiver is presumed, however, other output transducers are also suitable for the output to the user. The hearing aid is regularly assigned to a single user and is only used by this user. The input transducer generally generates an input signal which is applied to the signal processing unit. In the present case, the input transducer especially also generates the first audio signal, which is accordingly an input signal. The signal processing unit modifies the input signal and thus generates an output signal, which is thus a modified input signal. To compensate for hearing loss, the input signal is amplified, for example, according to an audiogram of the user using a frequency-dependent amplification factor. Alternatively or additionally, the input signal is modified in dependence on the HRTF. The output signal is finally output by means of the output transducer to the user.

The above-described recording and further output of a sound signal with modification on the electrical level is the regular case in operation of the hearing aid, this is also referred to as the “normal mode” of the hearing aid. In addition to the normal mode, the hearing aid described here preferably also has a streaming mode, in which the output to the user is based on the data signal, which is emitted by the audio source. The streaming mode has the advantage that a conversion into and conversion back from a sound signal can be omitted and also preferably an audio signal is transferred by the audio source in a lossless and uninfluenced manner to the user. The streaming mode is used, for example, to transmit an audio signal from a TV device, computer, or smart phone and in general from an audio source to the hearing aid. The hearing aid accordingly has a data input which is designed as complementary to the data output of the audio source, preferably also as an antenna. The statements on the data output also apply similarly to the data input and vice versa. The hearing aid is suitably designed in such a way that the user can switch between the normal mode and the streaming mode.

In the case of headphones or the like, the above-described normal mode is possibly omitted and the streaming mode is the general case.

In the present case, the functionalities of the normal mode and the streaming mode are now advantageously unified to determine the HRTF. On the one hand, the hearing aid receives the sound signal from the audio source by means of the microphone and thus uses the functionality of the normal mode. On the other hand, the hearing aid receives the data signal from the audio source and thus uses the functionality of the streaming mode. Which of the two audio signals (first and second audio signal) is then actually also output again via the receiver to the user is not important and is expediently left to the user. It is initially only relevant for the method described here that both audio signals are present to determine the HRTF based thereon.

Moreover, it is not absolutely required for the method described here that the hearing aid has a streaming mode or in general receives the data signal, this can also be received by another device. The first and the second audio signal solely have to be brought together on any arbitrary device, to be compared there and to determine the HRTF based thereon. In principle, the hearing aid is suitable for this purpose, however, a computer is also suitable, especially a server, which is regularly distinguished in relation to the hearing aid by a significantly higher computing power. It is also conceivable that the hearing aid does receive the data signal, but that the determination of the HRTF is not carried out by the hearing aid, but rather, for example, by the smart phone or server to which the hearing aid transmits the audio signals or the corresponding data sets.

However, it is important for the correct determination of the HRTF that the hearing aid receives the sound signal, because the hearing aid is worn by the user, while any other device is generally positioned outside the user and is therefore not suitable for receiving a sound signal which propagates along the acoustic path to the ear of the user. In one preferred embodiment, the hearing aid accordingly receives the sound signal using a microphone which is a part of the hearing aid. The hearing aid possibly even has multiple microphones, using which the sound signal is received and the first audio signal is generated. The hearing aid is expediently designed in such a way that in the worn state, the microphone is positioned in or on an ear of the user. In particular, the microphone is thus positioned behind the ear, in the ear, or in the auditory canal of the user. The precise position of the microphone is dependent on the type of the hearing aid. In a BTE device, the microphone is positioned behind the ear, in an RIC device in the auditory canal, and in an ITE device in the ear, but before the auditory canal. Therefore the entire acoustic path up into the auditory canal is possibly not taken into consideration and the HRTF is accordingly determined only for a part of the acoustic path, i.e., only for one single section or multiple sections, but not all sections of the acoustic path.

The hearing aid is either monaural and is then worn only on one side (left or right) of the head or binaural and then has two individual devices, which are worn on different sides of the head (i.e., left and right). In a binaural hearing aid, both individual devices each have one or more microphones for receiving sound signals.

A spatial situation with respect to the user is also preferred in the determination of the HRTF. This spatial situation is preferably selected from a set of spatial situations, comprising and in particular solely consisting of: a position of the user relative to the audio source, a distance of the user relative to the audio source, an orientation of the user relative to the audio source, an orientation of the head of the user relative to their torso, a posture of the user. The orientation of the head of the user relative to their torso is a special posture here, further postures are, e.g., sitting, lying, standing. The orientation of the head relative to the torso is preferably a head rotation around the longitudinal body axis of the user, a head inclination around the transverse axis of the user (i.e., nodding to the front/rear), or a lateral flexion (i.e., head inclination to one side).

In one suitable embodiment, a corresponding spatial situation is then ascertained and taken into consideration in the determination of the HRTF. This is based on the consideration that the acoustic path is generally dependent on how the body of the user is aligned relative to the audio source and/or which posture the user assumes, i.e., whether the sound signal reaches the user, for example, from the front, from the rear, or from the side and how their own body, especially the torso, shades the sound signal. Accordingly, the modification of the sound signal during its propagation to the ear of the user is dependent on the relative spatial relationship between user and audio source and the posture of the user, so that the HRTF is also generally situation-dependent and especially direction-dependent and posture-dependent. For the most optimum possible determination of the HRTF, it is accordingly advantageous not only to record as many data sets as possible in general, but also to record data sets for as many spatial situations as possible, i.e., in as many different relative spatial relationships of the user to the audio source as possible and/or for as many postures of the user as possible. The HRTF is thus accordingly advantageously determined in a situation-dependent and especially direction-dependent and/or posture-dependent manner.

How precisely the spatial situation is determined is of secondary importance in the present case and is therefore not further subject matter here, in principle any method known for this purpose is suitable. In one suitable embodiment, the hearing aid is a binaural hearing aid and accordingly receives the sound signal of the audio source on both sides. The orientation of the user relative to the audio source is then ascertained, for example, on the basis of a time offset or amplitude difference of the sound signal received on the two sides. Tracking of the user, for example, by means of a camera of the audio source or a beacon in an auxiliary device worn by the user is also conceivable and suitable. An embodiment is also suitable in which an absolute location of the audio source and the hearing aid is determined in each case and the relative spatial relationship is then determined by subtraction of the locations. The orientation of the head is ascertained, for example, by means of a video observation of the user, by means of a gyroscope or magnetometer, in particular of the hearing aid, or it is assumed that the orientation is assumed to be “looking straight ahead” if no change of the orientation has taken place for a longer time (for example, at least 1 minute).

A respective excerpt from the first and the second audio signal and a spatial situation with respect to the user are suitably jointly stored as a data set for determining the HRTF. A respective data set then contains not only one sample of each of the two audio signals, but also an item of information about the relative spatial relationship of the user to the audio source and/or the posture of the user at the point in time of this sample.

Generating data sets is possible in greatly varying ways, in particular with differing degrees of participation of the user and with or without special actuation of the audio source.

Primarily, an embodiment is suitable in which data sets are generated progressively without the user having to be active at all or the audio source having to be specially controlled. The method is therefore executed so to speak in the background when used as intended and therefore does not annoy the user.

In one suitable embodiment, the audio source is controlled in such a way that upon the presence of a spatial situation with respect to the user, for which a minimum number of data sets is not yet provided, it outputs a source audio signal to generate a data set for this spatial situation. In this embodiment, the audio source is accordingly specially controlled to deliberately generate a data set for those spatial situations for which sufficiently many data sets for an adequately good determination of the HRTF are not yet provided. How many data sets are actually required for a respective spatial situation, thus how large the minimum number is, is primarily not important. For example, the minimum number is only 1 or alternatively 10, 100, or 1000. A participation of the user is also not required in this embodiment, however, a special actuation of the audio source takes place to deliberately generate as many reasonable data sets as possible. The hearing aid or another device checks, for example, which position, distance, orientation, and/or posture is presently provided and whether the number of already provided data sets corresponds at least to the minimum number. If this is not the case, the audio source is actuated accordingly to output in this situation the source audio signal both as a sound signal and as a data signal, so that then a data set is generated for the present position, distance, orientation, and/or posture.

In one suitable embodiment, an instruction is output to the user to produce one or more spatial situations in each of which the audio source then outputs a source audio signal to generate a data set for each of these spatial situations. The instruction is output, for example, by the hearing aid, the audio source, or another device. The instruction is, for example, acoustic or optical. Whether the user actually follows the instruction is left to himself or herself. However, in any case there is the probability that the user produces the required spatial situation upon the instruction, so that a data set then can and also will be deliberately generated for it. The method uses a participation of the user, a special actuation of the audio source is not absolutely required, however.

An embodiment is also advantageous in which the hearing aid has a test mode and outputs an output signal to the user in this test mode, which has an item of spatial noise information (i.e., “spatial cue”, for example, a spatially localized noise), to prompt the user to move or orient themselves (as a whole or only with the head) in a provided direction, namely in particular toward where the noise supposedly comes from. Furthermore, it is then determined in which actual direction the user moves or orients themselves and this is compared to the provided direction to ascertain a degree of adaptation of the HRTF to the user. The degree of adaptation indicates in particular how well the presently determined HRTF corresponds to the actual HRTF. This is checked in the test mode in that the output signal is generated by means of the presently determined HRTF. If the presently determined HRTF deviates from the actual HRTF, the user will thus incorrectly locate the noise in a different direction than if a noise actually came from the provided direction and were modified by the actual HRTF. The test mode thus enables a check of the HRTF determined up to this point and also an ascertainment of how well this corresponds with the actual HRTF for the user. In one exemplary embodiment, the user is prompted to look in a specific direction with neutral pupil position. The data sets then obtained in this way are expediently used to test the degree of adaptation. This procedure is less demanding for the user than having them move through the space. In addition, data sets for missing spatial situations with respect to the orientation of the head in relation to the torso are expediently also recorded in this way.

The HRTF can in principle itself be decomposed into multiple individual transfer functions, which model individual sections of the acoustic path and which then result in the HRTF for the entire acoustic path when joined together. Under certain circumstances, it is not necessary or is even impossible to determine the HRTF for the entire acoustic path in the described manner, but rather only for one or more individual sections, especially those sections which are closest to the user. The remaining sections are then modeled in particular by means of a respective standard function.

In one expedient embodiment, the determination of the HRTF takes place starting from a base HRTF, which is a transfer function for only a first section of an acoustic path from the audio source to the auditory canal of the user, so that the HRTF is predominantly determined for another, second section of the acoustic path. This is based on the consideration that the HRTF is regularly defined most strongly by the ear of the user and especially their pinna and in contrast less by the torso of the user or their general head shape. Therefore, the second section in particular contains that part of the acoustic path which contains the pinna. The base HRTF is then, for example, an HRTF of a dummy and dominantly takes into consideration the body shape and general head shape of the user. This base HRTF is then optimized by the present method in such a way that the special shape of the pinna of the user is taken into consideration, so that overall the HRTF is determined in a user-specific manner. For this purpose, the hearing aid is expediently designed in such a way that its microphone is positioned in the worn state in the auditory canal or in the ear of the user and not solely behind the ear.

As already indicated, the HRTF is not necessarily determined by the hearing aid. The HRTF is preferably determined by a computer, in particular a server, which is formed separately from the hearing aid and the audio source. A server is presumed as the computer hereinafter without restriction of the generality. How precisely the data sets reach the server for this purpose is not of further relevance and is also dependent on the selected embodiment of the method, the hearing aid, the audio source, and other possibly participating devices. For example, the hearing aid transmits the first, acoustically transferred audio signal or excerpts thereof to the server, the second, acoustically transferred audio signal or excerpts thereof are also transmitted from the hearing aid or from another device, for example, a smart phone or the audio source, to the server. The server then in turn expediently transmits the HRTF to the hearing aid.

The audio source is preferably a stationary device. “Stationary” is understood in particular as unmoving, but not necessarily immobile in general. In other words: the audio source typically remains at the same point in an environment, for example, a space, while the user moves relative to the audio source and the spatial situation with respect to the user generally changes. A stationary device has the advantage in particular that any movement of the user automatically generates a change of the spatial situation, so that accordingly data sets for various spatial situations can be generated in a simple manner.

An embodiment is particularly preferred in which the audio source is a TV device, also referred to as a television. A TV device is in particular a stationary device. The use of a TV device as an audio source in a method as described here has various advantages. On the one hand, a TV device typically has one or more loudspeakers which have a high output quality and thus cover a particularly broad frequency spectrum and also output the source audio signal particularly faithfully. This particularly applies in comparison to a smart phone. In addition, the user typically stops at a distance of a few meters in relation to the TV device, which is similar to the distance in the determination of an HRTF in an echo-free room as described at the outset and which is optimum for determining the HRTF. In addition, the TV device is typically always placed at the same position in the environment, so that additional space-acoustic effects can be taken into consideration better in the determination of the HRTF, in particular along a section of the acoustic path which is not depicted by the HRTF. Finally, it is also to be expected that sound signals from a TV device do not contain sensitive personal data, in contrast, for example, to the case of sound signals from a smart phone.

The method described here is preferably carried out while the user watches television, in particular with the audio source, i.e., while the audio source, which is a TV device, is switched on and the user stops in its close environment (for example, within less than 5 m distant from the audio source). It is not absolutely necessary here that the user follows the content emitted by the TV device or gives it special attention. Carrying out the method while the user watches television has diverse advantages. On the one hand, it is to be expected that the user watches television over a longer period of time of, for example, 1 to 2 hours, so that accordingly particularly many data sets are recorded. It is also to be expected that the user repeatedly watches television, so that correspondingly many data sets are recorded repeatedly. Furthermore, typically no personal conversations of the user with other persons take place during the television watching, so that it is ensured that no sensitive personal data are recorded. If the contrary is the case, these data are expediently discarded. A personal conversation is recognized by the hearing aid, for example, in that the associated sound signal arrives from a different direction than the sound signal from the audio source. Other interference noises are also typically not present during the television watching, since other noise sources are regularly switched off by the user, so that overall data sets having very good quality are generated.

The use of a TV device is additionally advantageous since it regularly does have multiple loudspeakers, but is also operable in such a way here that only one ingle loudspeaker is used to output sound signals. The determination of the HRTF thus becomes significantly more accurate, since now only one single sound source is present and the acoustic path is thus very accurately defined. This also applies in general to all audio sources having multiple loudspeakers. In one advantageous embodiment, the audio source is therefore controlled in such a way that it outputs the audio signal as a sound signal via only one loudspeaker. The output via only one loudspeaker is not restricted to the user at least insofar as this user advantageously also receives the sound audio source if necessary by means of the streaming mode as a data signal and is accordingly not dependent on the sound output of the audio source. The hearing aid is preferably accordingly operated during the method in the streaming mode. If the additional sound output is perceived to be annoying, the sound signal is filtered out, for example, by the hearing aid by means of an ANC unit (ANC means “active noise canceling”).

In one expedient embodiment, an acoustic parameter of the environment is determined in order in particular to quantify one or more spatial-acoustic effects, and taken into consideration in the determination of the HRTF. Spatial-acoustic effects are, for example, reflections of the sound signal on walls or objects in the environment or a reverberation, especially in a room. Accordingly, acoustic parameters of the environment are a time or an amplitude which quantify a pulse response of the environment, an early reflection of the environment, or a reverberation of the environment. The acoustic parameter is determined, for example, using the hearing aid or using another device. It is also expedient to place an additional microphone in the space to determine the acoustic parameter in the environment.

A hearing aid according to the invention has a control unit which is designed to carry out a method as described above, possibly in combination with an audio source and/or another device as described.

The object is furthermore achieved in particular by a computer and/or another device, for example, a smart phone as described above.

Exemplary embodiments of the invention are explained in more detail hereinafter on the basis of a drawing. In the schematic figures:

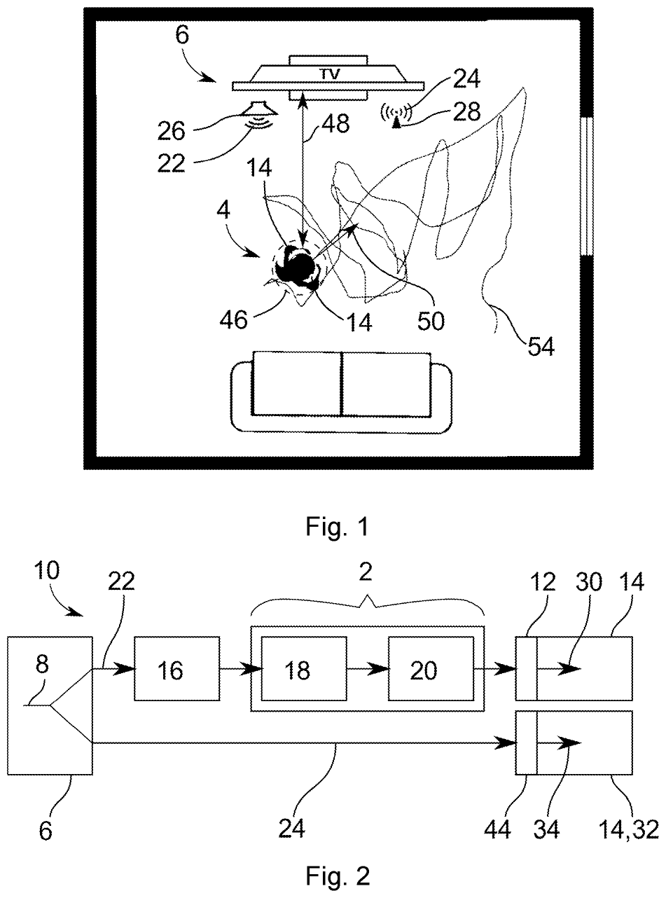

FIG. 1 shows an environment having an audio source and a user having a hearing aid,

FIG. 2 shows an acoustic path,

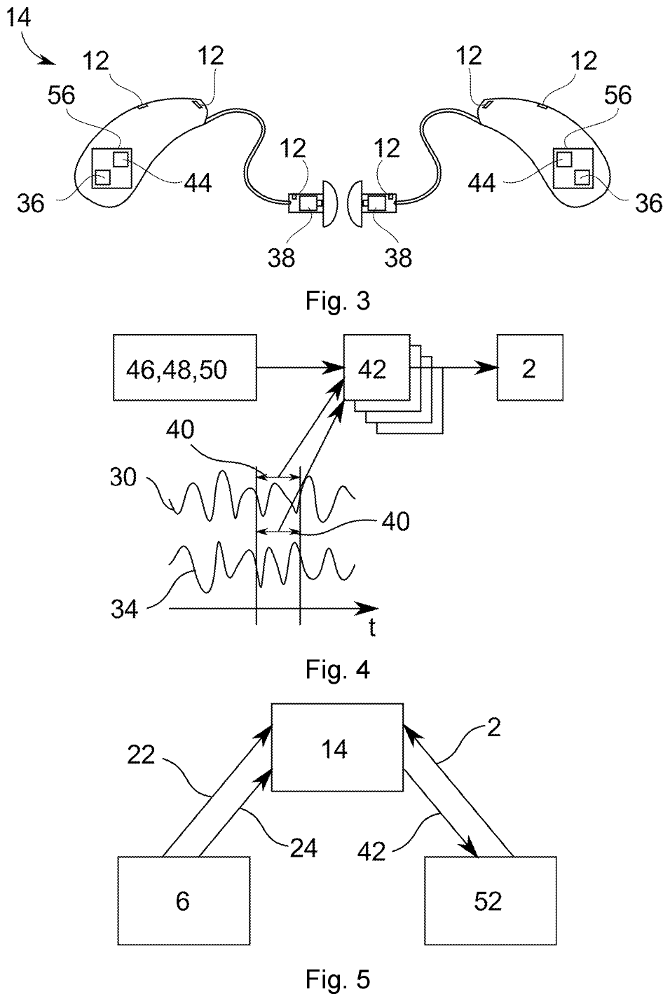

FIG. 3 shows a hearing aid,

FIG. 4 shows the determination of an HRTF from multiple data sets,

FIG. 5 shows an audio source, a hearing aid, and a computer.

A core concept of the present invention is illustrated in FIG. 1, namely to use an audio source 6, which can output a source audio signal 8 both acoustically and also non-acoustically, to determine an HRTF 2 for a specific user 4. The audio source 6 is a media device here and especially a TV device. The audio source 6 is used repeatedly by the user 4 in their everyday life. The acoustically output audio signal propagates along an acoustic path 10 to the user and especially to a microphone 12 of a hearing aid 14 of the user 4 and is modified along the acoustic path 10 by the body shape of the user 4.

An exemplary acoustic path 10 is shown in FIG. 2 and contains multiple sections 16, 18, 20. A first section 16 is defined by a first modification, which takes place independently of the user 4 due to the environment and is not of further importance here. A second section 18 is defined by a second modification which takes place due to the body shape (primarily torso shape) and head shape of the user 4. The second section 28 forms the acoustic path 10 via/along/through the body of the user 4 up to the ear or up to behind the ear of the user 4. A third modification 20 takes place due to the ear, especially the pinna of the user 4, and thus defines a third and also last section 20 here of the acoustic path 10 from outside the ear up into the auditory canal of the user 4. The sections 18, 20 are defined by a transfer function which corresponds to the actual, individual HRTF of the user 4. The non-acoustically output audio signal, in contrast, is in particular not modified by this HRTF 2, so that the HRTF 2 may be determined individually for the user by a comparison of the two differently transferred audio signals.

The method described here is generally used to determine an HRTF 2 (i.e., “head-related transfer function”). The determination of the HRTF 2 is carried out in a user-specific manner for a specific user 4. The audio source 6 outputs the source audio signal 8, namely both acoustically as a sound signal 22 and also non-acoustically as a data signal 24. The source audio signal 8 is an audio signal and as such is an electrical signal. For the acoustic output of the source audio signal 8, the audio source 6 has a loudspeaker 26. The same source audio signal 8 is also output on a further, non-acoustic channel, namely as the data signal 24. For the non-acoustic output of the source audio signal 8, the audio source 6 has a data output 28, in the exemplary embodiment shown an antenna for a wireless radio connection. A wired emission is also possible, however, the data output 28 is then a corresponding terminal. It is initially only essential that the same source audio signal 8 is output on two different channels, namely once acoustically as the sound signal 22 and once non-acoustically as the data signal 24.

The sound signal 22 is received by the hearing aid 14 and converted thereby back into an audio signal, namely into a first audio signal 30, which is also referred to as an “acoustically transferred audio signal”. Especially in a hearing aid 14 for treating a hearing-impaired user 4, receiving sound signals 22 from the environment is an original function of the hearing aid 16. The data signal 24 is received by the hearing aid 14 or by another device 32, which generates a second audio signal 34 from the data signal 24. For this purpose, the hearing aid 14 or the other device 32 accordingly has a data input 44, for example, an antenna. The other device 32 is an auxiliary device in the exemplary embodiment shown, which is connected for data exchange to the hearing aid 14, for example, a smart phone. The second audio signal 34 is also referred to as a “non-acoustically transferred audio signal”.

The first audio signal 30 and the second audio signal 34, i.e., the audio signals transferred on different channels, are compared to one another and based thereon, i.e., based on the comparison, the HRTF 2 is determined. The second audio signal 34 typically substantially corresponds to the source audio signal 8 and has at least not been influenced by the HRTF 2. In contrast thereto, the sound signal 22 was modified by the HRTF 2, so that the first audio signal 30 accordingly differs from the source audio signal 8. To determine the HRTF 2, for example, the first audio signal 30 is then used as an intended signal and the second audio signal 34 as an actual signal.

The HRTF 2 determined in the above-mentioned manner is stored in the present case in the hearing aid 14 and used by a signal processing unit 36 of the hearing aid 16 in operation, in order as a result to adapt the sound signal which is output by the hearing aid 14 to the user 4. An exemplary hearing aid 14 is shown in FIG. 3. The hearing aid 14 shown here is, without restriction of the generality, a hearing aid 14 for the treatment of a hearing-impaired user 4. However, the invention is also applicable to other hearing aids 16, for example, a set of headphones which additionally has one or more microphones. The hearing aid 14 shown here has an input transducer (namely the microphone 12), the above-mentioned signal processing unit 36, and an output transducer 38, a receiver here. The input transducer generates an input signal which is supplied to the signal processing unit 36. In the present case, the input transducer especially also generates the first audio signal 30, which is accordingly an input signal. The signal processing unit 36 modifies the input signal and thus generates an output signal, which is thus a modified input signal. To compensate for a hearing loss, the input signal is amplified, for example, according to an audiogram of the user 4 using a frequency-dependent amplification factor. Alternatively or additionally, the input signal is modified in dependence on the HRTF 2. The output signal is finally output by means of the output transducer 38 to the user 4.

In the embodiment shown here, to determine the HRTF 2, only excerpts 40, so-called samples, are taken from each of the first and the second audio signal 30, 34 and stored as a data set 42. This is illustrated in FIG. 4. The two excerpts 40 (one excerpt 40 from the first audio signal 30 and one excerpt 40 from the second audio signal 34) of a respective data set 42 also originate here from the same time interval or have a corresponding timestamp. A large number of data sets 42 are typically recorded and stored and evaluated to determine the HRTF 2. This takes place either on the hearing aid 14, on an auxiliary device as described, or on a separate computer, for example, a server.

The above-described recording and further output of a sound signal with modification on the electrical level is the normal case in operation of the hearing aid 16, this is also referred to as the “normal mode” of the hearing aid 16. In addition to the normal mode, the hearing aid 14 described here also has a streaming mode in which the output to the user 4 is based on the data signal 24 which is emitted by the audio source 6. In the streaming mode, a conversion into and back conversion out of a sound signal is dispensed with and an audio signal is transferred from the audio source 6 in a lossless and uninfluenced manner to the user 4. The streaming mode is used, for example, to transfer an audio signal 8 from a TV device, computer, or smart phone and in general from an audio source 6 to the hearing aid 14. The hearing aid 14 accordingly has a data input 44, which is made complementary to the data output 28 of the audio source, accordingly also as an antenna here.

In the present case, the functionalities of the normal mode and the streaming mode are now unified to determine the HRTF 2. The hearing aid 14, on the one hand, receives the sound signal 22 from the audio source 6 by means of the microphone 12 and thus uses the functionality of the normal mode. On the other hand, the hearing aid 14 receives the data signal 24 from the audio source 6 and thus uses the functionality of the streaming mode. Which of the two audio signals 30, 34 is then actually also output again via the output transducer 38 to the user 4 is not important and remains left, for example, to the user.

For the method described here, however, it is not absolutely necessary that the hearing aid 14 has a streaming mode or in general receives the data signal 24, this can also be received by another device 32. The first and the second audio signal 30, 34 solely have to be brought together on any arbitrary device, in order to be compared there and to determine the HRTF 2 based thereon.

However, it is important for the correct determination of the HRTF 2 that the hearing aid 14 receives the sound signal 22, because the hearing aid 14 is worn by the user 4, while any other device 32 is generally positioned outside the user 4 and is therefore not suitable for receiving a sound signal 22 which propagates along the acoustic path 10 to the user 4. In the embodiment shown here, the hearing aid 14 accordingly receives the sound signal 22 using a microphone 12, which is a part of the hearing aid 16. The hearing aid 14 shown here is moreover designed in such a way that in the worn state, the microphone 12 is positioned in or on an ear of the user 4. The precise position of the microphone 12 is dependent on the type of the hearing aid 16. In a BTE device, the microphone 12 is positioned behind the ear, in an RIC device in the auditory canal, and in an ITE device in the ear, but still before the auditory canal. Therefore, the entire acoustic path 10 up into the auditory canal is possibly not taken into consideration and the HRTF 2 is accordingly only determined for one or individual sections 18, 20 of the acoustic path 10. The hearing aid 14 is either monaural and is then worn only on one side (left or right) of the head or—as shown here—is binaural and then has two individual devices which are worn on different sides of the head (i.e., left and right). In a binaural hearing aid 14, both individual devices each have one or more microphones 12.

In the exemplary embodiment shown here, the spatial situation with respect to the user 4 is also taken into consideration in the determination of the HRTF 2, especially their relative spatial relationship to the audio source 6 here. The spatial situation is characterized in the exemplary embodiment shown by a position 46, distance 48, and/or orientation 50 of the user 4 relative to the audio source 6. In one variant (not explicitly shown), the spatial situation is alternatively or additionally especially an orientation of the head of the user 4 relative to their torso or in general a posture of the user 4. Other postures are, for example, seated, lying, standing. The acoustic path 10 is generally dependent on how the body of the user 4 is aligned relative to the audio source 6 or which posture the user 4 assumes, i.e., whether the sound signal 22 reaches the user 4 from the front, from the rear, or from the side and how their own body, especially the torso, shades the sound signal. Accordingly, the modification of the sound signal 22 during its propagation to the user 4 is dependent on the relative spatial relation between user 4 and audio source 6 and the posture of the user 4, so that the HRTF 2 is also situation-dependent and especially direction-dependent and posture-dependent. Data sets 42 are therefore recorded in as many different relative spatial situations as possible, i.e., for as many different positions 46, distances 48, orientations 50, and/or postures as possible. How precisely the spatial situation, e.g., the position 46, distance 48, and/or orientation 50 of the user 4 relative to the audio source 6 is determined is of secondary importance in the present case and is therefore not further subject matter. In any case, a respective excerpt 40 from the first and the second audio signal 30, 34 and a spatial situation are jointly stored as a data set 42 for determining the HRTF 2, so that a respective data set 42 then also contains an item of information about the spatial situation.

Generating data sets 42 is possible in greatly varying ways, in particular with different degrees of participation of the user 4 and with or without a special actuation of the audio source 6.

First, an embodiment is possible in which data sets 42 are generated progressively, without the user 4 having to be active at all or the audio source 6 having to be specially controlled. The method is therefore executed so to speak in the background during intended use and thus does not annoy the user 4.

Alternatively or additionally, the audio source 6 is controlled in such a way that it outputs a source audio signal 8 when a spatial situation is present for which a minimum number of data sets 42 is not yet provided, in order to generate a data set 42 for this spatial situation. In this embodiment, the audio source 6 is accordingly specially controlled to deliberately generate a data set 42 for those spatial situations for which sufficiently many data sets 42 for a sufficiently good determination of the HRTF 2 are not yet provided. How many data sets 42 are actually required for a respective spatial situation, thus how large the minimum number is, is primarily not important. For example, the minimum number is only 1 or alternatively 10, 100, or 1000. A participation of the user 4 is also not required in this embodiment, however, a special actuation of the audio source 6 is carried out to deliberately generate as many reasonable data sets 42 as possible.

Alternatively or additionally, an instruction is output to the user 4 to produce one or more spatial situations in each of which the audio source 6 then outputs a source audio signal 8 to generate a data set 42 for each of these spatial situations. The instruction is output, for example, by the hearing aid 14, the audio source 6, or another device 32. The instruction is, for example, acoustic or optical. Whether the user 4 actually follows the instruction remains left to himself or herself. The method then overall uses a participation of the user 4, a special actuation of the audio source 6 is not absolutely required, however.

Alternatively or additionally, the hearing aid 14 has a test mode and in this mode outputs an output signal to the user 4, which has an item of spatial noise information (i.e., “spatial cue”, for example, a spatially localized noise), to prompt the user 4 to move or orient themselves in a provided direction, namely in particular toward where the noise supposedly comes from. Furthermore, it is then determined in which actual direction the user 4 moves or orients themselves and this is compared to the provided direction in order to ascertain a degree of adaptation of the HRTF 2 to the user 4. The degree of adaptation then indicates, for example, how well the presently determined HRTF 2 corresponds to the actual HRTF 2. The test mode thus enables a check of the HRTF 2 determined up to this point and also an ascertainment of how well it corresponds to the actual HRTF 2 for the user 4.

As is already recognizable in FIG. 2, the HRTF 2 can in principle itself be decomposed into multiple individual transfer functions, which model individual sections (for example, the sections 18, 20) of the acoustic path 10 and which then result in the HRTF 2 for the entire acoustic path 10 when joined together. Under certain circumstances, it is not necessary or is even impossible to determine the HRTF 2 for the entire acoustic path 10 in the described manner, but rather only for one or more individual sections 18, 20, especially those sections 18, 20 which are closest to the user 4, above all the third section 20 here. The remaining sections 18 are then modeled, for example, by means of a respective standard function, especially also the section 16 which as such does not contribute to the HRTF, but the determination of which possibly corrupts it.

In one possible embodiment, the determination of the HRTF 2 is carried out starting from a base HRTF, which is a transfer function for only a first section 18, 20 of an acoustic path 10 from the audio source 6 to the auditory canal of the user 4, so that the HRTF 2 is predominantly determined for another, second section 18, 20 of the acoustic path 10. For example, the second section in particular contains that part of the acoustic path 10 which contains the pinna, the third section 20 in FIG. 2 here. The base HRTF is then, for example, an HRTF 2 of a dummy and predominantly takes into consideration the body shape and general head shape of the user 4. This base HRTF is then optimized by the present method in such a way that the special shape of the pinna of the user 4 is taken into consideration, so that overall the HRTF 2 is determined in a user-specific manner. For this purpose, the hearing aid 14 is designed, for example, in such a way that is microphone 12 is positioned in the worn state in the auditory canal or in the ear of the user 4 and not solely behind the ear.

The HRTF 2 is not necessarily determined by the hearing aid 14. In FIG. 5, for example, the HRTF 2 is determined by a computer 52, a server here, which is formed separately from the hearing aid 14 and the audio source 6. Precisely how the data sets 42 reach the server for this purpose is not of further relevance and is also dependent on the selected embodiment of the method, the hearing aid 14, the audio source 6, and other possibly participating devices 32. FIG. 5 insofar only shows one of many possible embodiments. Embodiments are possible, for example, in which the hearing aid 14 transmits the first, acoustically transferred audio signal 30 or excerpts 40 thereof to the server, the second, acoustically transferred audio signal 34 or excerpts 4 thereof are also transmitted by the hearing aid 14 or by another device 32, for example, a smart phone or the audio source 6, to the server, which then transmits the HRTF 2 to the hearing aid 14.

In the exemplary embodiment shown in FIG. 1, the audio source 6 is a stationary device and typically remains at the same point in the environment, for example, a room as shown, while the user 4 moves in relation to the audio source 6 and in general the spatial situation changes. Such a movement of the user 4 is illustrated in FIG. 1 by an exemplary movement path 54. Moreover, the audio source 6 is a TV device in the embodiment shown here. As is recognizable in FIG. 1, the user 4 typically stops at a distance of a few meters relative to the TV device, which is similar to the distance in the determination of an HRTF 2 in an echo-free room as described at the outset. In addition, the TV device is typically always placed at the same position in the environment, so that additional room-acoustic effects, especially along the first section 16, are taken into consideration better in the determination of the HRTF 2. The method described here is also then carried out especially while the user 4 watches television, i.e., while the audio source 6 is switched on and the user 4 stops in its close environment (for example, within less than 5 m distance from the audio source 6). It is not absolutely required here that the user 4 follows the content emitted by the TV device or gives it special attention. In one possible embodiment, the audio source 6 is moreover controlled in such a way that it only outputs the audio signal 8 as a sound signal 22 via a single loudspeaker 26, so that the acoustic path 10 is defined more accurately.

In addition, in one embodiment an acoustic parameter of the environment is also determined, in order to quantify one or more room-acoustic effects, and taken into consideration in the determination of the HRTF 2. A transfer function for the first section 16 is thus determined here. Room-acoustic effects are, for example, reflections of the sound signals on walls or objects in the environment or a reverberation, especially in a room. The acoustic parameter is determined, for example, using the hearing aid 14 or using another device 32.

The hearing aid 14 furthermore has a control unit 56, which is designed to carry out the method as described above, at least those steps of the method which are carried out by the hearing aid 14.

### LIST OF REFERENCE NUMERALS

### 2 HRTF

4 user
6 audio source
8 source audio signal
10 acoustic path
12 microphone
14 hearing aid
16 first section
18 second section
20 third section
22 sound signal
24 data signal
26 loudspeaker (of the audio source)
28 data output
30 first audio signal (from sound signal)
32 other device
34 second audio signal (from data signal)
36 signal processing
38 output transducer
40 excerpt (sample)
42 data set
44 data input
46 position
48 distance
50 orientation
52 computer (server)
54 movement path
56 control unit

1-15. (canceled)

16. A method for determining a head related transfer function, the method comprising:
a) outputting by an audio source a source audio signal, both acoustically as a sound signal and non-acoustically as a data signal;
b) receiving the sound signal by a hearing aid of a user and converting the sound signal by the hearing aid back into a first audio signal;
c) receiving the data signal and generating a second audio signal from the data signal; and
d) comparing the first audio signal and the second audio signal to one another and determining the HRTF based thereon.

17. The method according to claim 16, wherein step c) comprises receiving the data signal and generating a second audio signal by the hearing aid or by another device.

18. The method according to claim 16, which comprises determining the HRTF by using the first audio signal as an intended signal and using the second audio signal as an actual signal.

19. The method according to claim 16, which comprises receiving the sound signal by the hearing aid using a microphone, and wherein the hearing aid is formed to be worn with the microphone positioned in or on an ear of the user.

20. The method according to claim 16, which comprises:
ascertaining a spatial situation with respect to the user and taking the spatial situation into consideration in determining the HRTF; and
selecting the spatial situation with respect to the user from a set of spatial situations from the group consisting of:
a position of the user relative to the audio source;
a distance of the user relative to the audio source;
an orientation of the user relative to the audio source;
an orientation of the head of the user relative to their torso; and
a posture of the user.

21. The method according to claim 20, which comprises:
for determining the HRTF, jointly storing as a data set a respective excerpt from the first audio signal and the second audio signal and a spatial situation with respect to the user; and
controlling the audio source, upon a presence of a given spatial situation with respect to the user for which a minimum number of data sets is not yet provided, to output a source audio signal in order to generate a data set for the given spatial situation with respect to the user.

22. The method according to claim 20, which comprises outputting an instruction to the user to produce one or more spatial situations in each of which the audio source then outputs a source audio signal in order to generate a data set for each of the one or more spatial situations.

23. The method according to claim 16, which comprises:
in a test mode of the hearing aid, outputting an output signal to the user with an item of spatial noise information in order to prompt the user to move in a given direction; and
determining in which actual direction the user moves and comparing the actual direction with the given direction in order to ascertain a degree of adaptation of the HRTF to the user.

24. The method according to claim 16, which comprises determining the HRTF starting from a base HRTF, which is a transfer function for only a first section of an acoustic path from the audio source to an auditory canal of the user, and predominantly determining the HRTF for another, second section of the acoustic path.

25. The method according to claim 16, which comprises determining the HRTF by a computer, which is formed separately from the hearing aid and the audio source.

26. The method according to claim 16, wherein the audio source is a stationary device.

27. The method according to claim 16, wherein the audio source is a television device.

28. The method according to claim 27, which carrying out the method steps while the user is watching television.

29. The method according to claim 16, which comprises controlling the audio source to outputs the source audio signal as a sound signal via only a single loudspeaker.

30. The method according to claim 16, which comprises determining an acoustic parameter of the environment and taking the acoustic parameter of the environment into consideration in determining the HRTF.

31. A hearing aid, comprising a control unit configured to carry out the method according to claim 16.
